(19) United States
(12) Patent Application Publication
(10) Pub. No.: US 2008/0317256 A1
(43) Pub. Date: Dec. 25, 2008

(54) Method for Reproducing a Secondary Path in an Active Noise Reduction System

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/912,197

(22) PCT Filed: Apr. 21, 2006
(86) PCT No.: PCT/CH2006/000219

§ 371 Date: May 20, 2008

(30) Foreign Application Priority Data
Apr. 22, 2005 (CH) 727/05

(51) Int. Cl. G10K 11/178

(52) U.S. Cl. 381/71.11

(57) ABSTRACT

A method for reproducing a secondary path in an active noise reduction system comprising a transmission path (S, 9′, 10, 11), an adaptively adjustable filter (13), and an addition unit (14), the adaptively adjustable filter (13) being adjusted according to an output signal of the addition unit (14). A delay time (T) of a signal along the transmission path (8, 9, 10, 11) is eliminated in the transmission function of the adaptively adjustable filter (13) in order to generate the reproduction of the secondary path.

### RELATED APPLICATION

This is a U.S. national phase application under 35 U.S.C. §371 of International Application No. PCT/CH2006/000219 filed Apr. 21, 2006, and claiming priority of Switzerland Application No. 727/05 filed Apr. 22, 2005.

### TECHNICAL FIELD

The invention relates to a method for modeling a secondary path in an active noise reduction system comprising a transmission link, an adaptively variable filter and an addition unit, the adaptively variable filter being varied in dependence on an output signal of the addition unit, and to a method for operating an active noise reduction system.

### BACKGROUND AND SUMMARY

Noise sources are increasingly perceived as environmental pollution and are deemed to diminish the quality of life. Because, however, noise sources frequently cannot be avoided, methods for noise reduction based on the principle of wave cancellation have already been proposed.

The principle of active noise canceling (ANC) is based on the cancellation of sound waves by interferences. These interferences are generated by one or a plurality of electroacoustic transducers, for example by loudspeakers. The signal radiated by the electroacoustic transducers is calculated and continuously corrected with an algorithm suitable for this purpose. The signal to be emitted by the electroacoustic transducers is calculated from items of information provided by one or a plurality of sensors. These are, on the one hand, items of information about the nature of the signal to be minimized. For example, a microphone picking up the noise to be minimized can be used to this end. On the other hand, however, items of information about the remaining residual signal are necessary. Microphones can also be used for this purpose.

The fundamental principle applied in active noise reduction was described by Dr. Paul Lueg in a 1935 patent laid open under the number AT-141 998 B. This publication discloses how noise can be canceled in a tube by generating a signal of opposite phase.

An algorithm for active noise reduction requires items of information from at least one sensor (for example a microphone) that ascertains the residual error. Depending on the application and the algorithm employed, there is a further sensor that provides items of information about the nature of the signal to be minimized. Further, an adaptive noise reduction system requires one or a plurality of actuators (for example in the form of loudspeakers) to output the correction signal. The items of information from the sensors must be converted into an appropriate format by an analog-to-digital converter. After processing by the algorithm, the signal is reconverted by a digital-to-analog converter and transmitted to the actuators. These converters are subject to limitations in terms of both resolution and also dynamics.

When active noise canceling, hereinafter referred to as ANC, is applied, the stability of the algorithm employed is a crucial factor. At present a number of specific algorithms are in use, such as for example the LMS (least mean square) algorithm or the Fx-LMS algorithm related thereto. The Fx algorithms in particular exhibit good stability and can therefore be employed readily in an ANC system. The prefix “Fx” here refers to the modeling of the so-called secondary path, which contains the properties of the actuators, sensors, amplifiers, analog-to-digital converters, digital-to-analog converters and transmission pathway employed as well as all other effects on the signal to be transmitted. The secondary path is also referred to hereinafter as “component effect.”

Some current methods for ascertaining the secondary path (component effect) are described and their weaknesses are identified in what follows.

A complete ANC system having integrated secondary path is described in, among other places, the document “A New Structure for Feed-Forward Active Noise Control Systems with Online Secondary-Path Modeling,” which was published by the authors Muhammad Tahir Akthar, Masahide Abe and Masayuki Kawamat at the “International Workshop on Acoustic Echo and Noise Control (IWAENC2003)” at Kyoto in September 2003.

This document describes offline modeling of the secondary path (component effect). The known method for determining the secondary path is referred to as “offline modeling” because the properties of the secondary path are determined in advance and thus while the system is not in operation.

As soon as the component effect (secondary path properties) has been determined with the help of white noise, the LMS algorithm incorporates a filter modeling these properties into the calculation.

This method for determining the secondary path (component effect) has the following property in common: that for calculating the component effect (secondary path), the time delay occurring between actuator and sensor is regarded as independent of the frequency response. Because, however, this time delay is an important property of the secondary path, neglecting this time delay in modeling the component effect (secondary path) impairs the efficiency and stability of the entire system. The signal propagation time changes if the environmental parameters, such as for example the atmospheric pressure or the temperature, change. If the signal propagation time becomes shorter, the fact that the delay is specified in the model of the secondary path renders the algorithm too slow to yield a satisfactory result. As a consequence, the damping properties can turn out poorer, and in the extreme case an unstable system can come about.

A further method for determining the secondary path during operation is described by Sen M. Kuo in U.S. Pat. No. 5,940,519.

The idea in this method is as follows: In addition to the noise that is to be canceled, a signal is mixed in, and the properties of the secondary path (component effect) are determined from the change in this signal. The additional signal is filtered out again before the “anti-noise signal” is output via the actuator, in this case a loudspeaker. This method has the disadvantage that this signal is always present.

When a secondary path (component effect) model is used in ANC, its properties automatically flow into the calculation of the anti-noise. If the secondary path model contains a time delay, as is so in conventional models, the system is limited in that a change in signal propagation time can no longer be compensated. This is the case above all when the signal propagation time becomes shorter.

It is therefore an object of the invention to identify a method that does not exhibit the aforesaid disadvantages.

This object is achieved with the features of the method of the present invention for modeling a secondary path as described herein. Advantageous developments and a method for operating an active noise reduction system also disclosed.

The invention relates, first, to a method for modeling a secondary path in an active noise reduction system comprising a transmission link, an adaptively variable filter and an addition unit, the adaptively variable filter being varied in dependence on an output signal of the addition unit. The method according to the invention comprises the following steps:

A known signal is fed to the transmission link and to the adaptively variable filter, which exhibits a variable transfer function;
The adaptive filter, or rather its transfer function, is so varied that the output signal of the addition unit is minimal;
A delay time of a signal over the transmission link is eliminated in the transfer function of the adaptively variable filter in order to generate the secondary path model.

Thus, for the first time, a method is created wherewith the effect of signal propagation time on the secondary path model is no longer present, so that a substantial improvement is achieved in the system stability of the active noise reduction system.

In a development of the method according to the invention, the delay time is determined, a procedure based on the peak search method being employed in particular for the purpose. This makes it possible to ascertain the delay time with exceedingly high accuracy, which leads to generally good system behavior during later operation.

In a further development of the method according to the invention, the adaptively variable filter operates in the frequency domain.

In a still further development of the method according to the invention, white noise is fed to the transmission link and the adaptively variable filter as the known signal.

In a further development of the method according to the invention, a transformation is applied to transform the known signal from a time domain to a frequency domain before the known signal is fed to the adaptively variable filter, and a transformation is applied to transform an output signal of the transmission link from the time domain to the frequency domain before the output signal of the transmission link is fed to the addition unit.

In a still further development of the method according to the invention, only the amplitude spectrum is further employed in the transformation from the time domain to the frequency domain. In this way a further simplification is achieved in secondary path modeling and thus the efficiency is increased.

In a still further development of the method according to the invention, a known signal exhibiting a constant amplitude spectrum is fed to the adaptively variable filter, and a transformation is applied to transform an output signal of the transmission link from the time domain to the frequency domain before the output signal of the transmission link is fed to the addition unit.

In a further development of the method according to the invention, the phase spectrum of the known signal is not further employed. In this way a further simplification is achieved.

Finally, there is identified a method for operating an active noise reduction system comprising a transmission link, an adaptively variable filter and an addition unit, the adaptively variable filter being varied in dependence on an output signal of the addition unit, and a modeled secondary path acting on the adaptively variable filter in such fashion that secondary path effects are taken into account, the secondary path being modeled in accordance with the method described above.

In what follows, the invention is further explained on the basis of exemplary embodiments with reference to the Drawings.

### BRIEF DESCRIPTION OF DRAWINGS

FIG. 1 is a simplified circuit block diagram of a known method for determining the secondary path according to the offline modeling method;

FIG. 2 is a simplified block diagram, in schematic form, of an embodiment of a method according to the invention;

FIG. 3 is a further simplified block diagram of a known method for determining the properties of the secondary path;

FIG. 4 is a simplified illustration for explaining a method according to the invention;

FIG. 5 is a further simplified illustration for explaining a method according to the invention;

FIG. 6 is a further simplified block diagram of a method according to the invention;

FIG. 7 is a block diagram of a further embodiment of a method according to the invention;

FIG. 8 depicts an example of a signal waveform; and

FIG. 9 depicts a further example of a signal waveform.

### DETAILED DESCRIPTION

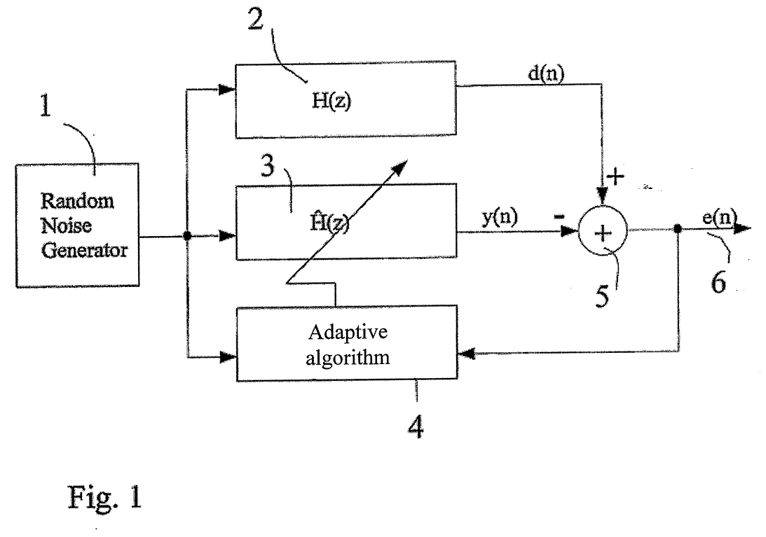

FIG. 1 comprises a noise generator unit 1, transmission pathway 2 having transfer function H(z), whose properties are to be modeled, and a filter 3, wherein a model Ĥ (z) of the actual transfer function H(z) is contained, which filter is controlled by an adaptive unit 4 wherein an adaptive algorithm is executed. Model Ĥ (z) is thus the model of transfer function H(z) in transmission pathway 2.

Transmission pathway 2, filter 3 and adaptive unit 4 are supplied with a signal randomly generated by noise generator unit 1 (random noise generator). From signals d(n), y(n) resulting at the output of transmission pathway 2 and filter 3, a sum is formed in an addition unit 5, output signal y(n) of filter 3 being inverted before addition.

Residual signal e(n) 6 resulting herefrom is fed to adaptive unit 4. The algorithm executed in adaptive unit 4 varies filter 3 in such a way that residual signal e(n) is minimized. An optimal adjustment of the entire system has been achieved when residual signal e(n) 6 is equal to zero. Transfer function H(z) coincides with model Ĥ(z) when this is the case.

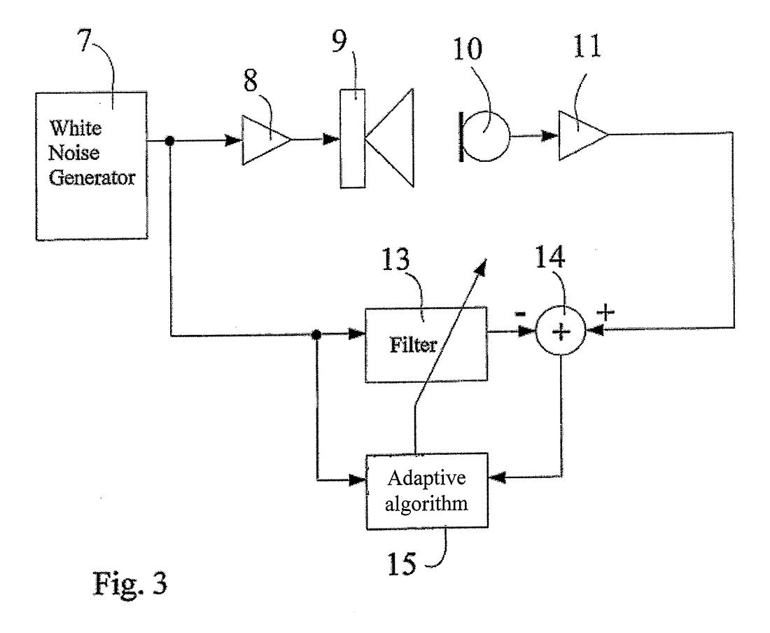

FIG. 3 depicts a known method for determining the properties of the secondary path (component effect). A transmission pathway is formed from an amplifier unit 8, an actuator 9 (a loudspeaker for example), a sensor 10 (a microphone for example) and a sensor amplifier 11. A noise generator unit 7 supplies this transmission pathway, filter 13 and adaptive unit 15 with white noise. The adaptive algorithm executed in adaptive unit 15 varies filter 13 in such a way that the result of addition unit 14 is minimized, it being necessary to invert one of the two summands. In this method, time delays attributable to the secondary path (component effect) flow into the calculation of filter 13. Here the secondary path (component effect) comprises the specific effect of amplifiers 8, 11, actuator 9, sensor 10 and the transmission medium between actuator 9 and sensor 10. This is just one of the possible ways in which a secondary path can be created. Instead of a loudspeaker and a microphone, other actuators and sensors can also be employed. Under some circumstances, microphone amplifier 11 can also contain a filter.

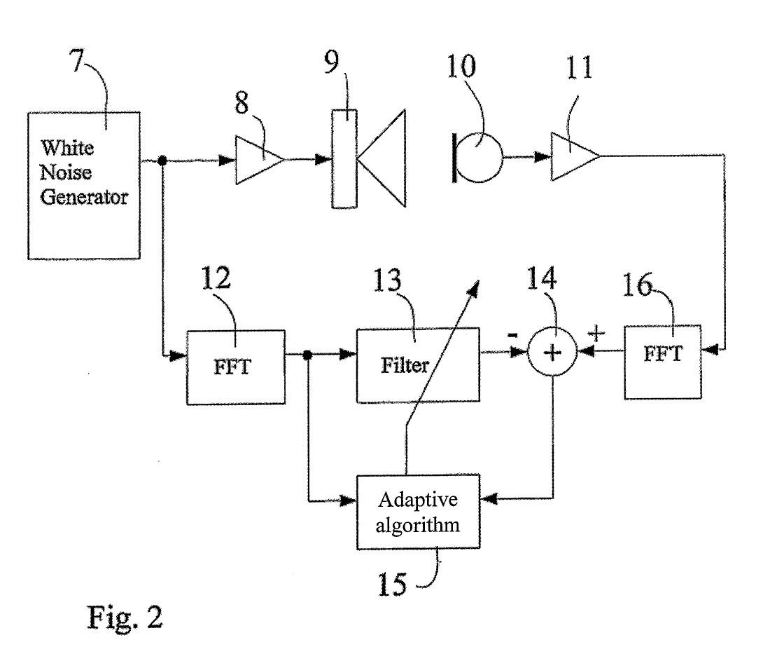

The invention now consists in that the effect due to signal propagation times arising in the secondary path is nullified by transforming the signals from the time domain to the frequency domain. This is illustrated with reference to the development according to the invention illustrated in FIG. 2.

FIG. 2 depicts the schematic structure of a system according to the invention for determining the properties of the secondary path (component effect) comprising the several components such as amplifier 8, actuator or loudspeaker 9, sensor or microphone 10, sensor amplifier or microphone amplifier 11 and the transmission medium between actuator 9 and sensor 10. Noise generator unit 7 supplies the secondary path with white noise. At the same time, the noise is fed to a transformation unit 12, which performs a transformation from the time domain to the frequency domain. A further transformation unit 16 transforms the signal at the end of the secondary path to the frequency domain. The adaptive algorithm applied in unit 15 varies filter 13 in such a way that the sum formed in addition unit 14 is minimized, the resulting signal from filter 13 being inverted before the sum is formed.

The transformation from the time domain to the frequency domain, carried out in transformation units 12 and 16, eliminates most of the temporal variation in propagation time arising in the secondary path. It has been found that certain signal components offset by a multiple of 2π cannot be eliminated. Thus filter 13 represents only the properties of the secondary path (component effect) in the frequency domain.

The distinction relative to the method depicted in FIG. 3 lies in the transformations from the time domain to the frequency domain, carried out in transformation units 12 and 16.

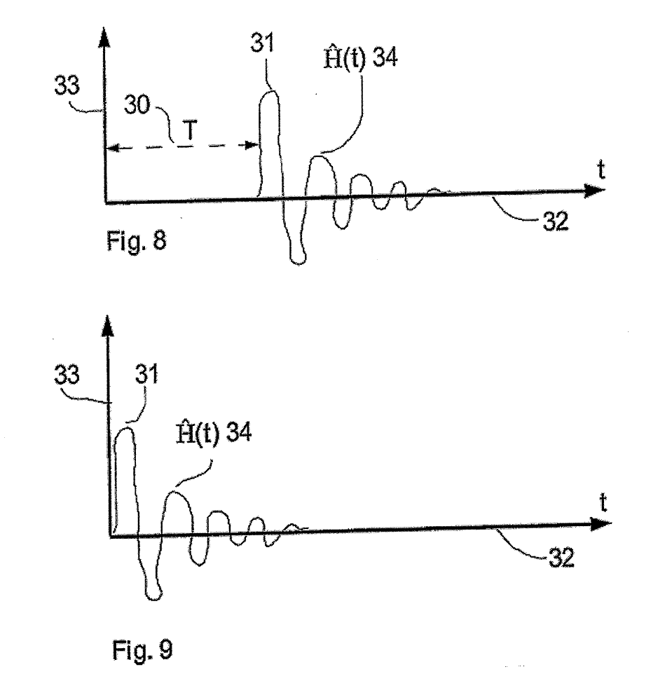

A further development of the method according to the invention, wherewith time delay T can be determined, is explained with reference to FIG. 8. What is illustrated in FIG. 8 is a possible impulse response Ĥ(t) of the transmission link, a signal being injected into the transmission link at time t=0. Time delay T, whose elimination is sought, is ascertained from impulse response Ĥ(t). To this end, the component in impulse response Ĥ(t) that occurs before a first maximum 31 of impulse response Ĥ(t) is removed, for example with a known peak search method, by looking backward for a certain number of sampling values in the information contained in the impulse response. In this way, after applying the peak search method, a waveform such as is illustrated in FIG. 9 is obtained. The advantage of this method for eliminating the time delay consists in that delay T can be determined very accurately.

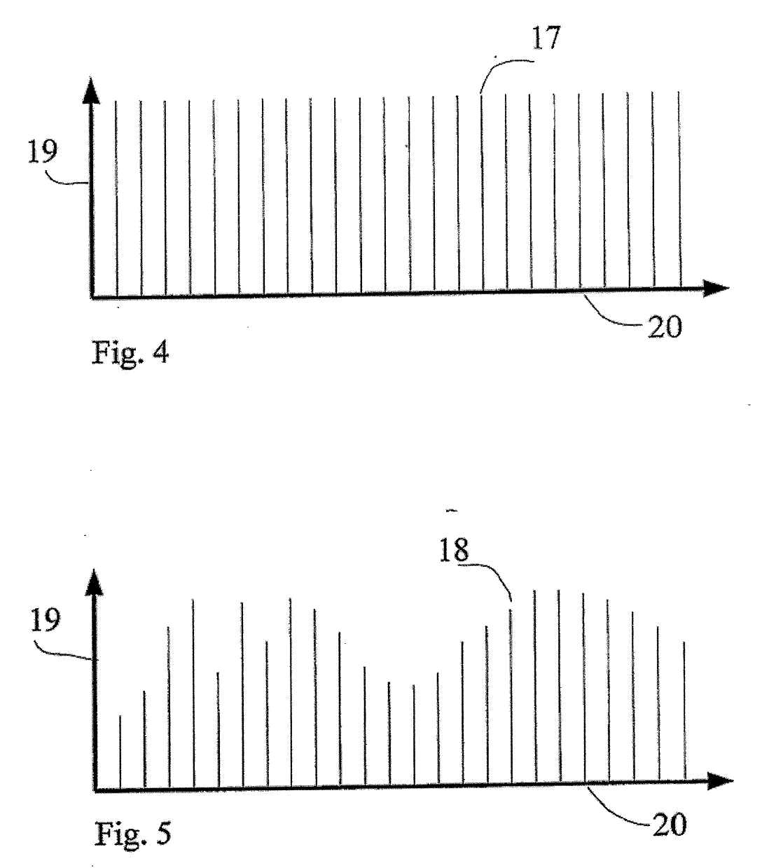

FIG. 4 depicts the frequency spectrum of white noise. Frequency 20 is plotted on the horizontal axis and amplitude 19 on the vertical axis. The spectrum shows a constant behavior of amplitude 17.

FIG. 5 depicts the frequency spectrum after the white noise according to FIG. 4 has passed through the secondary path. Again frequency 20 is plotted on the horizontal axis and amplitude 19 on the vertical axis. The spectrum now no longer shows a constant amplitude spectrum but rather an amplitude spectrum that varies with the frequency. This amplitude spectrum depicts a possible output signal in the frequency domain of a secondary path after the secondary path has been excited with the spectrum according to FIG. 4.

In FIG. 2 white noise is generated by noise generator unit 1, which means that amplitude 17 is equally large for each individual frequency. This is illustrated in FIG. 4.

Now after the white noise has passed through the secondary path, amplitude 18 is no longer equally large for every frequency, as can be seen in FIG. 5.

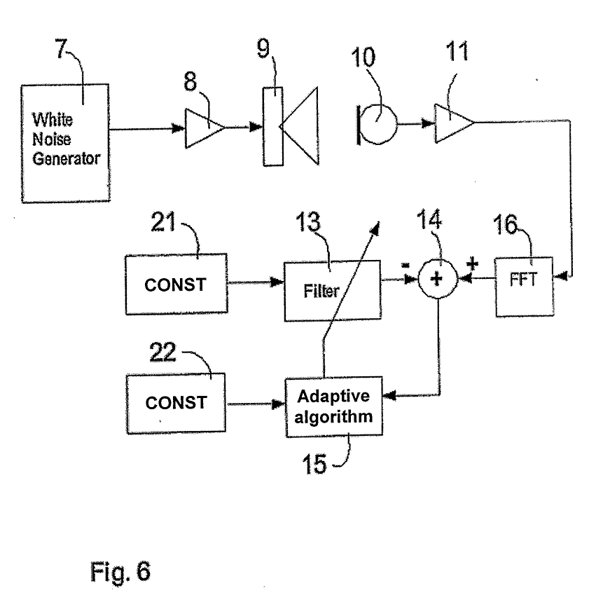

FIG. 6 is a block diagram having two noise generators 21 and 22 wherein white noise is generated. In order to calculate the secondary path, a constant value is employed at the input of filter 13 and at adaptive unit 15. The use of a number—in this case a constant value instead of a complex signal—is a further simplification in the modeling of the secondary path.

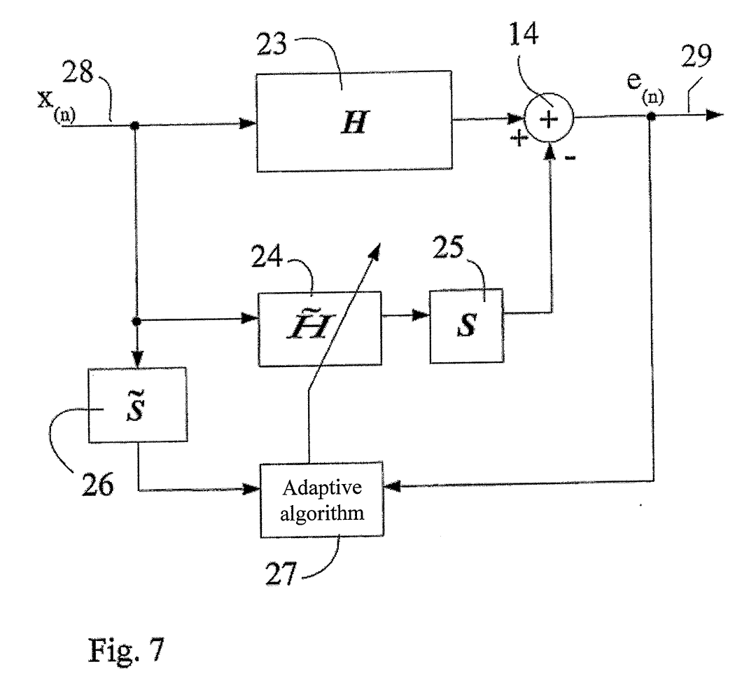

A simple ANC system is depicted in FIG. 7. In what follows, the mode of functioning of an ANC system whose secondary path has been ascertained in the frequency domain is explained.

Reference character 28 denotes x(n), the signal to be minimized; 29, the remaining residual signal e(n); 23, the transmission link with transfer function H; and 24, filter Ĥ wherewith transmission link H is modeled. Blocks 25 and 26 merit special attention. Thus 25 denotes the secondary path (component effect), while 26 denotes an estimate of the secondary path (component effect). Thus block 26 stores the parameters previously ascertained with reference to the methods described in FIG. 2 and FIG. 3.

When the known method described in FIG. 3 is used, the limitations already described above come into play; specifically, the temporal variation of the signal propagation time in the secondary path is not taken into account. If the effect due to signal propagation time is large in block 26, it can no longer be corrected by filter 24.

If, in contrast, the parameters have been ascertained by the method according to the invention as described in FIG. 2, the signal propagation time no longer affects the model of the secondary path. Before the parameters ascertained in filter 13 (FIG. 2 or 6) are stored in the secondary path model (block 26), however, an inverse transformation must be applied to transform them back from the frequency domain to the time domain. Thus block 26 describes the frequency properties of secondary path 25. In addition unit 14, once again, a sum is formed after x(n), the signal to be minimized, has been subjected to the operation of transmission link 23 on the one hand and filter 24 and secondary path 25 on the other hand. It should be noted that one of the two summands must be inverted for the formation of a difference with addition unit 14, as can be seen in the figure. Adaptive unit 27, in which an adaptive algorithm is executed, controls filter 24 in such a way that residual signal e(n) 29 is as small as possible, that is, minimal.

1. A method for modeling a secondary path in an active noise reduction system comprising a transmission link (8, 9, 10, 11), an adaptively variable filter (13) and an addition unit (14), the adaptively variable filter (13) being varied in dependence on an output signal of the addition unit (14), the method comprising the steps:
A known signal is fed to the transmission link (8, 9, 10, 11) and to the adaptively variable filter (13), which exhibits a variable transfer function;
The adaptive filter (13), or rather its transfer function, is so varied that the output signal of the addition unit (14) is minimal;
A delay time (T) of a signal over the transmission link (8, 9, 10, 11) is eliminated in the transfer function of the adaptively variable filter (13) in order to generate the secondary path model.

2. The method of claim 1, wherein the delay time (T) is determined, a procedure based on the peak search method being employed in particular for the purpose.

3. The method of claim 1, wherein the adaptively variable filter (13) operates in the frequency domain.

4. The method of claim 1 or 3, wherein white noise is fed to the transmission link (8, 9, 10, 11) and the adaptively variable filter (13) as the known signal.

5. The method of claim 1 or 3 wherein a transformation is applied to transform the known signal from a time domain to a frequency domain before the known signal is fed to the adaptively variable filter (13), and wherein a transformation is applied to transform an output signal of the transmission link (8, 9, 10, 11) from the time domain to the frequency domain before the output signal of the transmission link (8, 9, 10, 11) is fed to the addition unit (14).

6. The method of claim 5, wherein only the amplitude spectrum is further employed in the transformation from the time domain to the frequency domain.

7. The method of claim 1 or 3 wherein a known signal exhibiting a constant amplitude spectrum is fed to the adaptively variable filter (13), and wherein a transformation is applied to transform an output signal of the transmission link (8, 9, 10, 11) from the time domain to the frequency domain before the output signal of the transmission link (8, 9, 10, 11) is fed to the addition unit (14).

8. The method of claim 7, wherein the phase spectrum of the known signal is not further employed.

9. A method for operating an active noise reduction system comprising a transmission link (8, 9, 10, 11), an adaptively variable filter (13) and an addition unit (14), the adaptively variable filter (13) being varied in dependence on an output signal of the addition unit (14) and a modeled secondary path acting on the adaptively variable filter (13) in such a way that secondary path effects are taken into account, wherein the secondary path is modeled in accordance with claim 1.
